(19) United States
(12) Patent Application Publication
(10) Pub. No.: US 2014/0347143 A1
(43) Pub. Date: Nov. 27, 2014

(54) Balancing Circuit

(71) Applicant: Ralph Oppelt, Uttenreuth (DE)

(72) Inventor: Ralph Oppelt, Uttenreuth (DE)

(21) Appl. No.: 14/284,114

(22) Filed: May 21, 2014

(30) Foreign Application Priority Data
May 22, 2013 (DE) DE 102013209450.7

(51) Int. Cl. H03H 7/42

(52) U.S. Cl. CPC H01P 1/18
USPC 333/25

(57) ABSTRACT

A balancing circuit comprises a first conductor path and a second conductor path. The first and second conductor paths are arranged in parallel with one another with respect to a signal flow. The first conductor path and the second conductor path are formed by a first stage and a second stage. The first conductor path has a high-pass member that is assigned to the first stage and a high-pass member that is assigned to the second stage. The second conductor path has a low-pass member that is assigned to the first stage and a low-pass member that is assigned to the second stage. Each high-pass member is designed to shift a signal forward in terms of phase by a predetermined amount, and each low-pass member is designed to shift a signal backward in terms of phase by a predetermined amount, in order to generate a balanced or unbalanced signal.

This application claims the benefit of DE 10 2013 209 450.7, filed on May 22, 2013, which is hereby incorporated by reference in its entirety.

### BACKGROUND

The present embodiments relate to converting a balanced signal into an unbalanced signal or for converting an unbalanced signal into a balanced signal.

In different circuits, balanced or unbalanced signals may be transmitted. In this connection, balanced signals are also understood to be “differential” or “balanced-to-ground” signals. Unbalanced signals may also be “single-ended” or “unbalanced-to-ground” signals.

In the case of a balanced transmission, an identically configured return conductor is assigned to each forward conductor. The two conductors therefore always occur in pairs and may also be twisted together. As a result, possible disturbances caused by radio signals or magnetic fields may act practically identically on both wires (e.g., common-mode signal). The useful signal (e.g., differential signal) may be obtained in the receiver by determining the voltage difference between the two lines. In the case of the determination, a common-mode interference signal, which therefore is equally present in both lines, is removed again. In contrast to this, in the case of unbalanced transmission, disturbance that is shone in only has an effect on one conductor since the return conductor is the system ground. Thus, the disturbance may not be eliminated by difference formation here.

Depending on the application, balanced signals may be converted into unbalanced signals or vice versa. By way of example, a Boucherot bridge, as described in DE 102011005349 A1 or in H. Meinke, F. W. Gundlach: “Taschenbuch der Hochfrequenztechnik,” Pocket Book of Radio-frequency Engineering, Springer Verlag, 3rd edition, 1968, pp. 1437-1438, may be used for this purpose.

A Boucherot bridge of this type essentially includes two discrete conductor paths: one path (e.g., high-pass branch) that effects a forward rotation in terms of phase by 90°, and one path (e.g., low-pass branch) that effects a backward rotation in terms of phase by 90°. In general, the known Boucherot bridge is used to generate a balanced signal from an unbalanced signal or vice versa. However, the known Boucherot bridge is narrow-band since the voltages with respect to ground appearing at the output or input ports of the Boucherot bridge are precisely identical in magnitude only at a single frequency. This provides that a conversion of the signals from balanced to unbalanced or vice versa may be performed only in a narrow frequency range.

For balancing applications in which a broader frequency band is to be provided (e.g., in magnetic resonance imaging (MRI)), transformers, including line transformers or baluns are used. Thus, for example, two-decade bandwidths may be covered by wound cores of ferrite. Ferrites fail in magnetic fields (e.g., in the patient area of an MRI system) since the ferrites saturate. Therefore, the transmitter is to be composed of air-coupled windings. Components such as this may not be customary on the market but are made to order and are therefore relatively expensive. By contrast, simple coils or inductors, as are required, for example, for a narrow-band Boucherot bridge, may be obtained inexpensively on the market in a ferrite-free design.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a balancing circuit and a method for converting signals, in which a conversion may be performed using cost-effective components over a broad frequency range, are provided.

A balancing circuit for converting a balanced signal into an unbalanced signal or for converting an unbalanced signal into a balanced signal is provided. The balancing circuit includes a first conductor path and a second conductor path. The first conductor path and the second conductor path are arranged in parallel with one another with respect to the signal flow. The first conductor path and the second conductor path are formed by a first stage and a second stage. The first conductor path has a high-pass member that is assigned to the first stage and a high-pass member that is assigned to the second stage. The high-pass members are arranged in a sequence. The second conductor path has a low-pass member that is assigned to the first stage and a low-pass member that is assigned to the second stage. The low-pass members are arranged in a sequence. Each high-pass member is configured to shift a signal forward in terms of phase by a predetermined amount, and each low-pass member is configured to shift a signal backward in terms of phase by a predetermined amount in order to generate a signal. The sum of the phase shifts in the first conductor path is approximately +90° (or π/2), and the sum of the phase shifts in the second conductor path is approximately −90° (or −π/2).

A broad-band balancing circuit may be provided using an at least two-stage arrangement of the conductor paths. In this case, conventional components may be used. Thus, the balancing circuit may be constructed in a ferrite-free manner. In this way, the balancing circuit may also be used in applications that should be ferrite-free. Thus, the balancing circuit may be used, for example, in a patient area of a magnetic resonance imaging system.

The balancing circuit has two conductor paths. A first part of the first conductor path and a first part of the second conductor path together form a first stage of the balancing circuit, and a second part of the first conductor path and a second part of the second conductor path together form a second stage of the balancing circuit. In each stage, a signal is shifted forward in terms of phase by a certain amount (e.g., shifted in the leading direction) in the first conductor path, and is shifted backward in terms of phase by a certain amount (e.g., shifted in the lagging direction) in the second conductor path.

The conversion from balanced to unbalanced or from unbalanced to balanced is achieved owing to this separation into two conductor paths. Since each conductor path causes a shift of +90° or −90°, the total phase shift of the balancing circuit is 180°. At the same time, an impedance conversion may be performed. An impedance of the input signal is converted into a different impedance of the output signal.

The first conductor path has two high-pass members. Each high-pass member acts as a discrete high-pass conductor element and, as a result, shifts the signal forward in terms of phase. In contrast, the second conductor path has two low-pass members. Each low-pass member acts as a discrete low-pass conductor element and, as a result, shifts the signal backward in terms of phase. The sum of the phase shift per conductor path is approximately ±90°. By separating the phase shift into multiple stages (e.g., two stages), a broader bandwidth may be achieved with simple components. The sum of the phase shift per conductor path is dependent on the respective frequency of the signal. Depending on the frequency, the achieved phase shift is slightly under ±90° or slightly over ±90 (e.g., approximately ±90°). The sum of the phase shift may be +90° or −90° per conductor path.

Depending on the sort of balancing circuit, a balanced (e.g., via two inputs or two ports) or unbalanced (e.g., via one input or one port) input signal is received, and an unbalanced (e.g., via one output or one port) or balanced (e.g., via two outputs or two ports) output signal is correspondingly output. This is explained in more detail below.

According to one embodiment, the balancing circuit has one input for receiving an unbalanced signal and two outputs for outputting a balanced signal, where the first conductor path and the second conductor path are coupled on the input-side. According to another embodiment, the balancing circuit has two inputs for receiving a balanced signal and one output for outputting an unbalanced signal, where the first conductor path and the second conductor path are coupled on the output-side.

If the conductor paths are connected in parallel on one side, a network having three ports is obtained. For a conversion from balanced to unbalanced, the conductor paths are coupled on the output-side, with the result that the port resulting from the parallel connection is designated as output, and the two other ports are designated as input. Correspondingly, for a conversion from unbalanced to balanced, the conductor paths are coupled on the input-side, with the result that the port resulting from the parallel connection is designated as input, and the two other ports are designated as output.

Owing to the purely passive structure of the balancing circuit, the signal flow may also run in the opposite direction, with the result that the terms input and output are to be understood with respect to the signal flow.

In one or more cases of application, the impedance of the balanced port is four times as high as that of the unbalanced port. For example, an adaptation from 50Ω unbalanced to 200Ω balanced may take place. Therefore, in one embodiment, each conductor path may be dimensioned for an impedance of 100Ω.

Owing to the (approximately) ±90° phase rotation of each conductor path, each conductor path has a λ/4 property, where λ denotes the wavelength. Each conductor path may therefore also be used in an impedance-transforming manner, if required. By way of example, the balancing circuit may include two 100Ω conductor paths and adapts an unbalanced source impedance of, for example, 100Ω to a balanced 100Ω load. Each conductor path may therefore be a λ/4 transformer and transform from 200Ω “single-ended” or unbalanced to 50Ω “single-ended” or unbalanced. No coupling of the conductor paths is assumed. In the case of an input-side parallel connection, this results in 100Ω “single-ended” or unbalanced at the input and 100Ω “differential” or balanced at the output.

According to another embodiment, the first stage and the second stage of the first conductor path and of the second conductor path form a two-stage Boucherot bridge.

The first stage of the first conductor path and the first stage of the second conductor path may therefore include the known structures of discrete conductor elements. This also applies to the second stage of the first conductor path and the second stage of the second conductor path. The combination of the two stages and amalgamation of parallel components and optional omission of the parallel tuned circuit structure at the common port thus results in a two-stage Boucherot bridge.

According to another embodiment, a first half of the power of the input signal is transmitted via the first conductor path, and a second half of the power of the input signal is transmitted via the second conductor path.

Depending on the type of the balancing circuit (e.g., balanced to unbalanced or unbalanced to balanced), the input signal already includes two parts, as is the case with a balanced signal, or of only one signal. In each case, the input signal is separated across the two conductor paths, where, in the case of a balanced signal, the already existing parts are each assigned to a conductor path.

According to another embodiment, the first conductor path and the second conductor path are configured to adapt the input impedance of a signal to an output impedance.

As discussed above, the impedance may be adapted in addition to the conversion from balanced to unbalanced or unbalanced to balanced. In this way, for example, a higher impedance may be present at the input than at the output.

According to another embodiment, the high-pass members are high-pass pi members, and the low-pass members are low-pass pi members.

A pi member may include three resistors of which one is in series with the transmission line and of which two connect the transmission line to a second conductor before and after the resistor that is arranged in parallel. A pi member is used as a damping member.

For the use as a high-pass pi member, the resistor that is in series is replaced by a capacitive component. The two other resistors are replaced by inductive components.

For the use as a low-pass pi member, the resistor that is in series is replaced by an inductive component. The two other resistors are replaced by capacitive components.

According to another embodiment, each high-pass member has in each case one capacitor and two coils, and each low-pass member has in each case one coil and two capacitors. At the common port, the coil of the high-pass member is connected in parallel with the capacitor of the low-pass member. The capacitors or coils at the interface of the sequence connection are connected in parallel.

The capacitive and inductive components of the pi members are formed by capacitors and coils. As discussed above, ferrite-free coils (e.g., coils without ferrite cores) may be used owing to the step-like arrangement. In this way, the balancing circuit may be used for broad-band applications without being restricted by the coils or other components (e.g., by the costs or areas of application).

According to another embodiment, each high-pass member has one capacitor and one coil, and each low-pass member has one coil and one capacitor.

The embodiment relates to a reduction in the components based on the above-mentioned embodiment. Owing to the arrangement of the components, the coils and capacitors may be partially amalgamated (e.g., at the interface of the sequence connection) or may be omitted (e.g., at the common port).

According to another embodiment, the first conductor path has N stages, and the second conductor path has N stages, where each stage of the first conductor path has a high-pass member, and each stage of the second conductor path has a low-pass member.

The balancing circuit may have any number of stages. The bandwidth of the balancing circuit may be increased using a higher number of stages. In this embodiment, N may be greater than or equal to 2 (N≧2).

According to another embodiment, the high-pass member of each stage is configured to shift the input signal forward in terms of phase by a predetermined amount such that the sum of the phase shift in the first conductor path is approximately +90°.

The total sum of the phase shift in the first conductor path is therefore +90°. This may be arbitrarily distributed between the individual high-pass members.

According to another embodiment, the predetermined amount for each stage is 90°/N.

In this case, the high-pass members or the individual stages of the first conductor path may be identically constructed. The phase shift is divided equally among all the stages.

According to another embodiment, the low-pass member of each stage is designed to shift the input signal backward in terms of phase by a predetermined amount such that the sum of the phase shift in the second conductor path is approximately −90°.

The total sum of the phase shift in the second conductor path is therefore −90°. As with the high-pass members, the phase shift may be arbitrarily distributed between the individual low-pass members.

According to another embodiment, the predetermined amount is −90°/N.

According to the embodiment, the low-pass members or stages may be identically constructed since an equal distribution of the phase shift is to be achieved.

According to another embodiment, the predetermined amount is different for each stage.

Any other distribution of the phase shift may also be provided. Thus, for example, in the first conductor path, a shift of +40° may take place in the first stage and a shift of +25° may take place in a second and third stage, respectively. The shift in the first conductor path and the second conductor path may be configured to be symmetrical. This, however, is not compulsory.

According to another aspect, a device including a balancing circuit that has the features mentioned above is provided. A device of this type may be, for example, a magnetic resonance imaging system.

According to another aspect, a method for converting a balanced signal into an unbalanced signal or for converting an unbalanced signal into a balanced signal is provided. The method includes receiving an input signal and shifting a signal forward in terms of phase by a predetermined amount using a first high-pass member of a first conductor path and a second high-pass member of the first conductor path. The first high-pass member of the first conductor path is assigned to a first stage of a balancing circuit, and the second high-pass member of the first conductor path is assigned to a second stage of the balancing circuit. The high-pass members are arranged in a sequence. The method also includes shifting a signal backward in terms of phase by a predetermined amount using a first low-pass member of a second conductor path and a second low-pass member of the second conductor path. The first low-pass member is assigned to the first stage of the balancing circuit. The second low-pass member is assigned to the second stage of the balancing circuit. The low-pass members are arranged in a sequence. The sum of the phase shifts in the first conductor path is approximately +90°, and the sum of the phase shifts in the second conductor path is approximately −90°. The method also includes outputting a converted output signal.

A computer program product that causes the implementation of the method as explained above on a program-controlled device is also provided.

By way of example, a computer program product such as a computer program, for example, may be provided or supplied as a storage medium (e.g., memory card, USB stick, CD-ROM, DVD) or in the form of a downloadable file from a server in a network. This may take place, for example, in a wireless communications network using the transmission of an appropriate file with the computer program product or the computer program.

The embodiments and features described for the proposed device correspondingly apply to the proposed method.

Other possible implementations of the invention also include combinations, not cited explicitly, of features or embodiments that are described above or below with respect to the exemplary embodiments. In this case, a person skilled in the art may also add individual aspects as improvements or additions to the respective basic form of the invention.

### BRIEF DESCRIPTION OF THE DRAWINGS

FIG. 1 shows an embodiment of a balancing circuit for converting a balanced signal into an unbalanced signal or vice versa;

FIG. 2 shows one embodiment of a balancing circuit for converting a balanced signal into an unbalanced signal or vice versa;

FIG. 3 shows one embodiment of a network with reduced components of the balancing circuit from FIG. 2;

FIG. 4 shows a graph of an exemplary signal profile of the signals at the input and output of the balancing circuit from FIG. 3;

FIG. 5 shows one embodiment of a balancing circuit for converting a balanced signal into an unbalanced signal or vice versa;

FIG. 6 shows one embodiment of a network with reduced components of the balancing circuit from FIG. 5;

FIG. 7 shows a graph of an exemplary signal profile of the signals at the output of the balancing circuit from FIG. 6 in comparison with an exemplary signal profile of the signals at the output of the balancing circuit from FIG. 3;

FIG. 8 shows a graph of an exemplary profile of a reflection factor (adaptation) at a common output of the balancing circuit from FIG. 6 in comparison with an exemplary profile of a reflection factor at a common output of the balancing circuit from FIG. 3;

FIG. 9 shows a graph of an exemplary profile of a reflection factor at a common output of the balancing circuit from FIG. 5 in comparison with an exemplary profile of a reflection factor at an output of the balancing circuit from FIG. 2; and

FIG. 10 shows a flow chart of an exemplary embodiment of a method for converting a balanced signal into an unbalanced signal or vice versa.

### DETAILED DESCRIPTION

In the figures, the same or functionally same elements are provided with the same reference signs unless otherwise specified.

In different applications, balanced signals and unbalanced signals may be transmitted. In many cases, a balanced signal may be converted into an unbalanced signal. Boucherot bridges may be used for this purpose.

A known Boucherot bridge 200, 300 is described below in connection with FIGS. 2 and 3. The Boucherot bridge substantially includes two discrete conductor paths 210, 220 (e.g., a first conductor path and a second conductor path). The first conductor path 220 forms a path (e.g., high-pass branch) that effects a forward rotation in terms of phase of approximately 90°. The second conductor path 210 forms a path (e.g., low-pass branch) that effects a backward rotation in terms of phase of approximately 90°.

The conductor paths 210, 220 may be coupled (e.g., connected to one another) on one side. If the conductor paths 210, 220 are connected in parallel on one side, a network having three ports 201, 202, 203 is obtained.

The low-pass branch or the second conductor path 210 is formed by a pi member having one coil L and two capacitors C. The capacitors C are connected to ground. The high-pass branch or the first conductor path 220 is formed by a pi member having one capacitor C and two coils L. The coils L are connected to ground.

The two elements L and C that are in parallel (e.g., the first coil L of the first conductor path 220 and the first capacitor C of the second conductor path 210) form a parallel tuned circuit at the operating frequency. Therefore, the elements may be omitted, which leads to a network 300 with reduced components as shown in FIG. 3.

In this embodiment, the port 1 201, which arises because of the parallel connection, serves as input, and the two other ports 2 202 and 3 203 serve as output. Owing to the purely passive structure, the signal flow may also run in the opposite direction, with the result that the terms input and output and the functions connected therewith may also be interchanged.

In general, the Boucherot bridge 200, 300 known from the prior art is used to generate a balanced (e.g., “differential” or “balanced-to-ground”) signal from an unbalanced (e.g., “single-ended” or “unbalanced-to-ground”) signal, or vice versa. In most cases of application, the impedance of the balanced port 202, 203 is four times as high as the impedance of the unbalanced port 201. By way of example, an adaptation from 50Ω unbalanced to 200Ω balanced may occur. Thus, each conductor path 210, 220 may be configured for an impedance of 100Ω. However, each conductor path 210, 220 may also be used in an impedance-transforming manner, if required. Consequently, the Boucherot network 200, 300, which includes two 100Ω conductor paths 210, 220, would also adapt an unbalanced source impedance of, for example, 100Ω to a balanced 100Ω load. Each conductor path 210, 220 would therefore transform from 200Ω “single-ended” to 50Ω “single-ended”. In the case of a parallel connection on the input-side, this corresponds to an input impedance of 100Ω “single-ended” and to an output impedance of 100Ω “differential” at the output 202, 203.

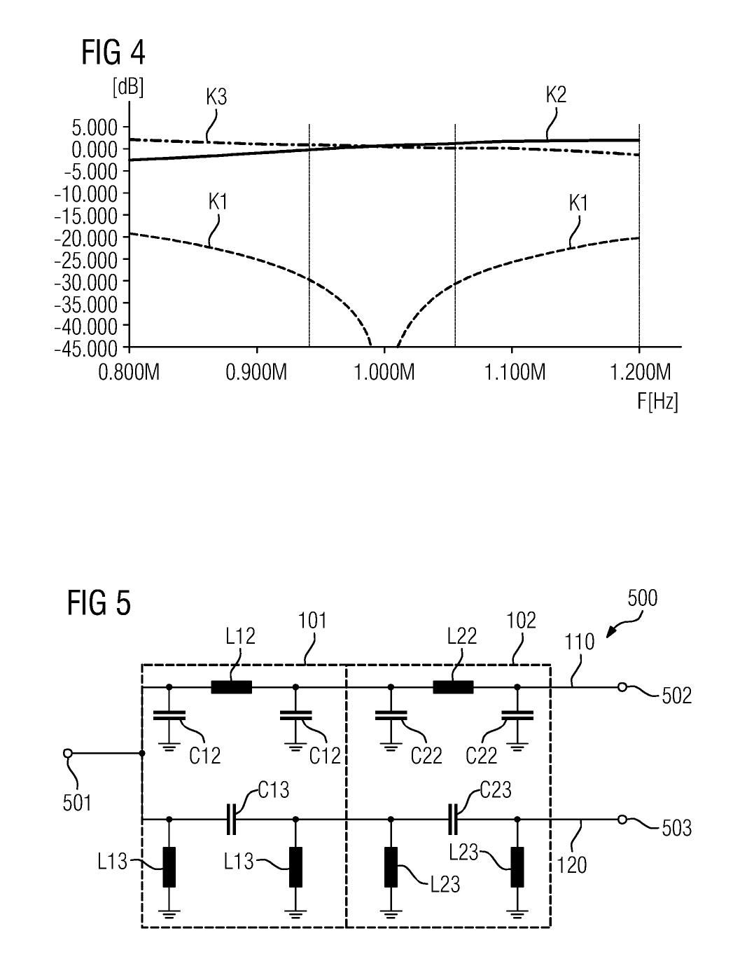

The known Boucherot bridge 200, 300 is narrow-band since the voltages appearing at the output ports 202, 203 with respect to ground are the same in magnitude only at a single frequency. If a certain amplitude imbalance is tolerated, then a certain bandwidth may also be used. If, for example, in the case of a 1:4 impedance transformation, an amplitude imbalance of ±0.5 dB is accepted, then a relative bandwidth of approximately 11.6% may be used. This is shown in FIG. 4.

FIG. 4 illustrates a simulation of a Boucherot bridge according to FIG. 3 with a transformation from 50Ω unbalanced to 200Ω balanced, dimensioned for 1 MHz. The ±0.5 dB transmission bandwidth, illustrated by the curves K2, K3, is only 116 kHz or 11.6%. In this range, the adaptation at the unbalanced port 201 (curve K1) is at least 30 dB.

However, for many applications (e.g., in the case of magnetic resonance imaging), a wider-band balancing circuit is necessary or desirable. For such broad-band balancing applications, transformers (e.g., line transformers or baluns) may be used. The transformers have wound cores. Thus, for example, two-decade bandwidths may be covered by wound cores of ferrite. Ferrites fail in magnetic fields (e.g., in the patient area of a magnetic resonance imaging system), since the ferrites saturate. Therefore, the transmitter includes air-coupled windings. Components such as this may not be customary on the market but are to be made to order and are therefore relatively expensive. By contrast, simple coils or inductors, as are used, for example, in the examples shown in FIGS. 2 and 3 for a Boucherot bridge 200, 300, are available inexpensively on the market in a ferrite-free design. However, a broad-band balancing application may not be achieved using the Boucherot bridge 200, 300 from FIGS. 2 and 3.

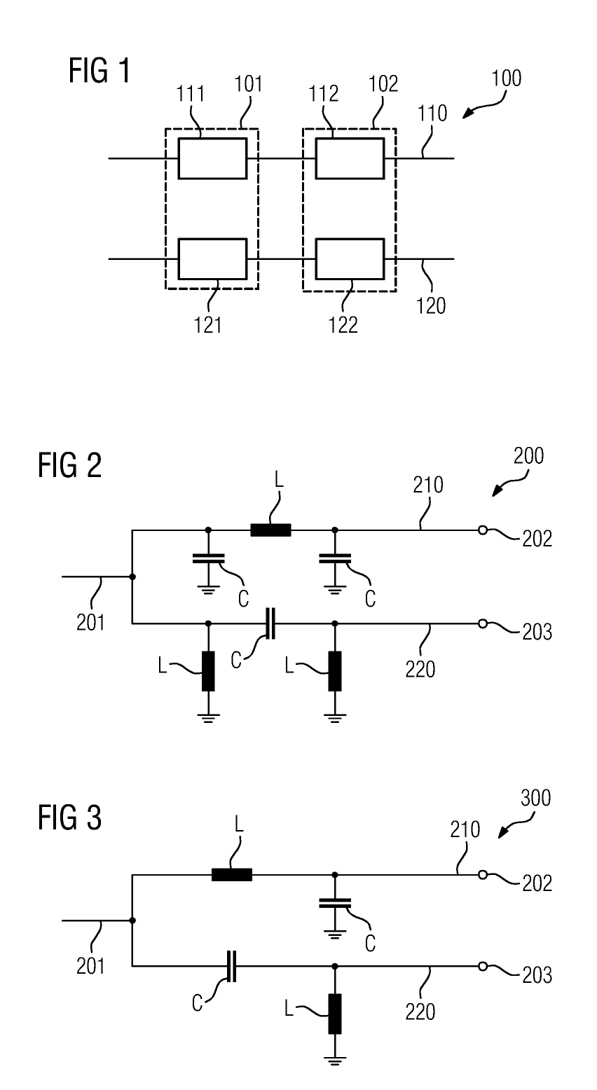

FIG. 1 shows one embodiment of a balancing circuit 100, by which a broad-band balancing application is provided. The balancing circuit 100 may be used to convert a balanced signal into an unbalanced signal or an unbalanced signal into a balanced signal. For this purpose, no ferrite cores or transmitters with air-coupled windings are used. Instead, the conversion of signals for a broad frequency band is achieved using an arrangement in stages.

For this purpose, the balancing circuit 100 has a first conductor path 120 and a second conductor path 110. The first conductor path 120 and the second conductor path 110 are arranged in parallel with one another with respect to the signal flow. Depending on the case of application (e.g., the type of conversion), the first conductor path 120 and the second conductor path 110 may be coupled on the input-side or on the output-side. This is explained in more detail in connection with FIGS. 2 and 3, and FIGS. 5 and 6.

As shown in FIG. 1, the first conductor path 120 and the second conductor path 110 form a first stage 101 and a second stage 102. More precisely, a first part of the first conductor path 120 and a first part of the second conductor path 110 form the first stage 101. A second part of the first conductor path 120 and a second part of the second conductor path 110 form the second stage 102.

The first conductor path 120 has a high-pass member 121, 122 in each stage. The high-pass members 121, 122 are arranged in a sequence. The second conductor path 110 has a low-pass member 111, 112 in each stage. The low-pass members 111, 112 are likewise arranged in a sequence. A two-stage Boucherot bridge is formed by this arrangement.

In other embodiments, the balancing circuit 100 may form a multi-stage Boucherot bridge by other stages being formed.

Each high-pass member 121, 122 is designed to shift a signal forward in terms of phase by a predetermined amount. In a similar manner, each low-pass member 111, 112 is designed to shift a signal backward in terms of phase by a predetermined amount. Using the phase shift, which is +90° in the first conductor path 120 and −90° in the second conductor path 110, a balanced signal is converted into an unbalanced signal, or an unbalanced signal is converted into a balanced signal.

In contrast to the known Boucherot bridge 200, 300, as described in FIGS. 2 and 3, a broad-band conversion may be achieved by the balancing circuit 100 without expensive components having to be used for this purpose.

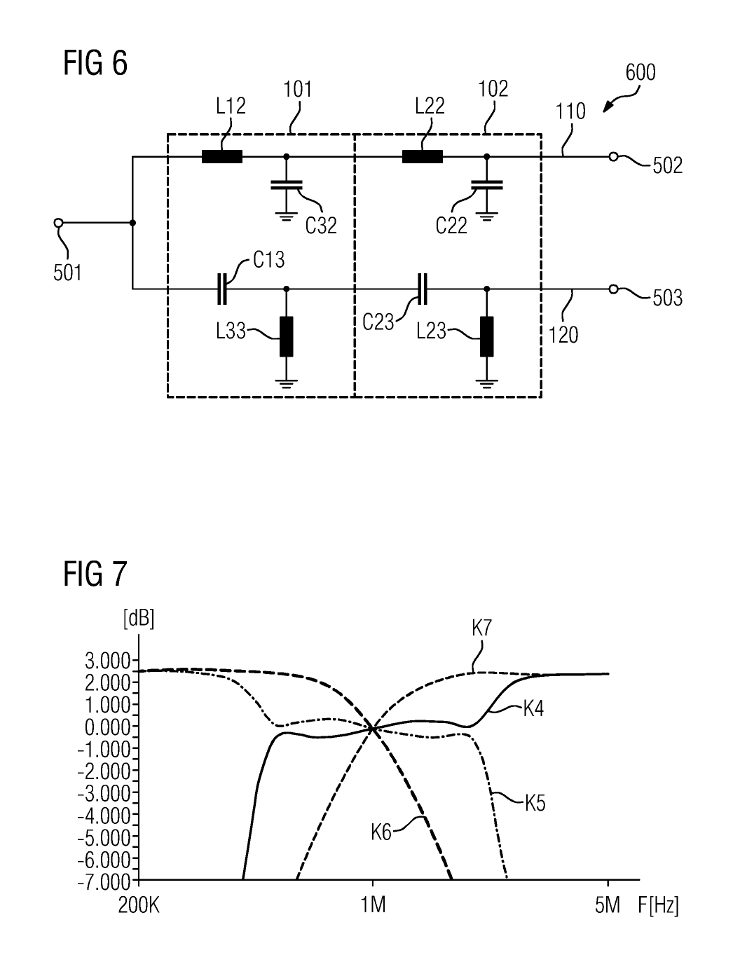

Another embodiment of the balancing circuit 100 from FIG. 1 is shown in FIGS. 5 and 6. FIG. 5 shows one embodiment of a balancing circuit 500, and FIG. 6 shows one embodiment of a network 600 with reduced components.

In order to increase the bandwidth, a Boucherot network or a balancing circuit 500, 600 may be constructed from several stages 101, 102. If N stages are used, each stage 101, 102 separately effects a phase rotation of +90°/N or −90°/N approximately in the band center (e.g., the geometric center from the band limits). In the case of a two-stage network 500, 600, that is therefore +45° or −45°. Other distributions of the phase shift may be provided.

The balancing circuit 500 includes two stages 101, 102. Each stage 101, 102 of the second conductor path 110 includes one coil L12, L22 and two capacitors C12, C22. Each stage 101, 102 of the first conductor path 120 includes one capacitor C13, C23 and two coils L13, L23. The first conductor path 120 and the second conductor path 110 are coupled on the input-side. As a result of this, one input 501 and two outputs 502, 503 are formed.

Similarly to the case of the single-stage network 200, 300, the LC elements C12, L13 that are in parallel may be omitted at the port 1 501. The elements C12, C22 and L13, L23 that are in each case in parallel may be combined to form a common capacitance C32 or, respectively, a common inductance L33 at the interface of the stages 101, 102 that are connected in a sequence. This therefore results in a structure 600 as illustrated in FIG. 6. Hence, a broad-band balancing member 500, 600 that may even be used in the magnetic field may be produced in a cost-effective manner.

The network 600 with reduced components has only two coils L33 and L23 in the first conductor path 120, where L33=L13//L23=L13L23/(L13+L23). In the second conductor path 110, the balancing circuit 600 has only two capacitors, where C32=C12+C22. The balancing circuit 500, 600 may also be correspondingly extended to three, four or N stages.

FIG. 7 shows an exemplary simulated calculation run for a two-stage arrangement according to FIG. 6. The output voltages at the high-pass path 120 (curve K4) and at the low-pass path 110 (curve K5) of the two-stage Boucherot network 600 show a bandwidth that is approximately ten times larger compared with the Boucherot bridge 300 from FIG. 3. The corresponding voltages of the single-stage network 200, 300 are shown by curves K7 (e.g., output voltage at the high-pass path 220) and K6 (e.g., output voltage at the low-pass path 210). The ±0.5 dB transmission bandwidth now stretches, for example, from 0.5 to 2 MHz and has therefore increased from 116 kHz to approximately 1.5 MHz.

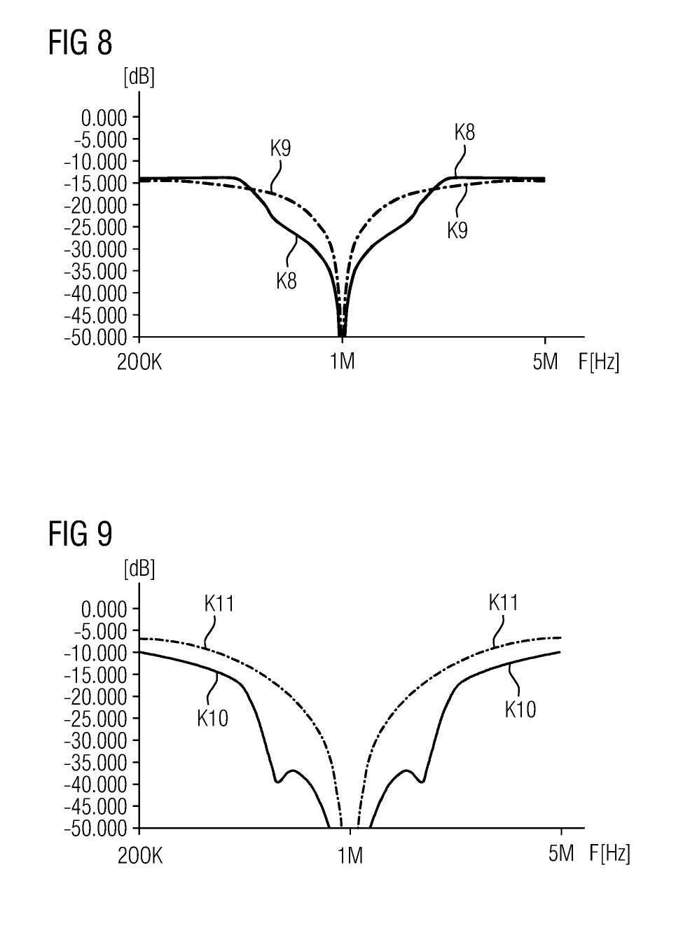

As shown in FIGS. 8 and 9, the multi-stage nature enables the impedance adaptation to be expanded too. In this connection, FIG. 8 shows the adaptation at the common port 1 501 in the case of the networks 300, 600 with reduced components, and FIG. 9 shows the adaptation at the common port 1 501 in the case of the Boucherot bridge circuits 200, 500. The adaptation in the circuits 500, 600 is shown by the curves K8 and K10, and the adaptation in the circuits 200, 300 is shown by the curves K9 and K11. An expansion of the adaptation is achieved by the balancing circuit 500, 600. With the addition of the parallel LC elements C12, L13 (e.g., without the component reduction at the common port 1 501), a good adaptation may be achieved, even over large bandwidths.

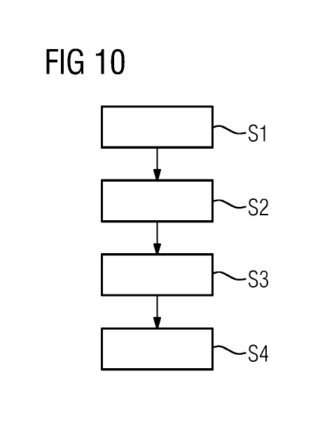

FIG. 10 shows one embodiment of a method for converting balanced signals into unbalanced signals or vice versa. For this purpose, the balancing circuit 100, 500 or 600 may be used.

In act S1, an input signal is received. This input signal may be balanced or unbalanced.

In act S2, the input signal or at least a part of the input signal is shifted forward in terms of phase by a predetermined amount. For this purpose, a first stage 101 and a second stage 102 of a first conductor path 120 are used. The first stage 101 and the second stage 102 have in each case a high-pass member 121, 122 and are arranged in a sequence.

In act S3, which may be carried out at the same time as the act S2, the input signal or at least a part of the input signal is shifted backward in terms of phase by a predetermined amount. For this purpose, a first stage 101 and a second stage 102 of a second conductor path 110 are used. The first stage 101 and the second stage 102 have in each case a low-pass member 111, 112 and are arranged in a sequence.

The sum of the phase shift in the first conductor path 120 is +90°. The sum of the phase shift in the second conductor path 110 is −90°. In act S4, the converted output signal is output.

Although the present invention has been described on the basis of exemplary embodiments, the present invention may be modified in many ways.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A balancing circuit for converting a balanced signal into an unbalanced signal or for converting an unbalanced signal into a balanced signal, the balancing circuit comprising:
a first conductor path; and
a second conductor path,
wherein the first conductor path and the second conductor path are arranged in parallel with one another with respect to a signal flow,
wherein the first conductor path and the second conductor path form a first stage and a second stage,
wherein the first conductor path has a high-pass member that is assigned to the first stage and a high-pass member that is assigned to the second stage, the high-pass members being arranged in a sequence,
wherein the second conductor path has a low-pass member that is assigned to the first stage and a low-pass member that is assigned to the second stage, the low-pass members being arranged in a sequence,
wherein each of the high-pass members is configured to shift a signal forward in terms of phase by a predetermined amount,
wherein each of the low-pass members is configured to shift a signal backward in terms of phase by a predetermined amount in order to generate a balanced or unbalanced signal,
wherein a sum of the phase shifts in the first conductor path is approximately +90°, and
wherein a sum of the phase shifts in the second conductor path is approximately −90°.

2. The balancing circuit of claim 1, further comprising one input operable for receiving an unbalanced signal and two outputs operable for outputting a balanced signal,
wherein the first conductor path and the second conductor path are coupled on the input-side.

3. The balancing circuit of claim 1, further comprising two inputs operable for receiving a balanced signal and one output operable for outputting an unbalanced signal, wherein the first conductor path and the second conductor path are coupled on the output-side.

4. The balancing circuit of claim 1, wherein the first stage and the second stage of the first conductor path and of the second conductor path form a two-stage Boucherot bridge.

5. The balancing circuit of claim 1, wherein a first half of a power of an input signal is transmitted via the first conductor path, and a second half of the power of the input signal is transmitted via the second conductor path.

6. The balancing circuit of claim 1, wherein the first conductor path and the second conductor path are configured to adapt an input impedance of a signal to an output impedance.

7. The balancing circuit of claim 1, wherein the high-pass members are high-pass pi members, and the low-pass members are low-pass pi members.

8. The balancing circuit of claim 1, wherein each of the high-pass members comprises one capacitor and two coils, and
wherein each of the low-pass members comprises one coil and two capacitors,
wherein one of the two coils of the high-pass member is connected in parallel with one of the two capacitors of the low-pass member.

9. The balancing circuit of claim 1, wherein each of the high-pass members comprises one capacitor and one coil, and
wherein each of the low-pass members comprises one coil and one capacitor.

10. The balancing circuit of claim 1, wherein the first conductor path has N stages, and the second conductor path has N stages, and
wherein each stage of the first conductor path has a high-pass member, and each stage of the second conductor path has a low-pass member.

11. The balancing circuit of claim 10, wherein the high-pass member of each stage is configured to shift the input signal forward in terms of phase by a predetermined amount such that the sum of the phase shift in the first conductor path is approximately +90°.

12. The balancing circuit of claim 11, wherein the predetermined amount for each stage is 90°/N.

13. The balancing circuit of claim 10, wherein the low-pass member of each stage is configured to shift the input signal backward in terms of phase by a predetermined amount such that the sum of the phase shift in the second conductor path is approximately −90°.

14. The balancing circuit of claim 13, wherein the predetermined amount is −90°/N.

15. The balancing circuit of claim 2, wherein the first stage and the second stage of the first conductor path and of the second conductor path form a two-stage Boucherot bridge.

16. The balancing circuit of claim 15, wherein a first half of a power of an input signal is transmitted via the first conductor path, and a second half of the power of the input signal is transmitted via the second conductor path.

17. The balancing circuit of claim 3, wherein the first stage and the second stage of the first conductor path and of the second conductor path form a two-stage Boucherot bridge.

18. The balancing circuit of claim 17, wherein a first half of a power of an input signal is transmitted via the first conductor path, and a second half of the power of the input signal is transmitted via the second conductor path.

19. The balancing circuit of claim 18, wherein the first conductor path and the second conductor path are configured to adapt an input impedance of a signal to an output impedance.

20. A method for converting a balanced signal into an unbalanced signal or for converting an unbalanced signal into a balanced signal, the method comprising:
receiving an input signal;
shifting a signal forward in terms of phase by a predetermined amount using a first high-pass member and a second high-pass member of a first conductor path, the first high-pass member being assigned to a first stage of a balancing circuit, and the second high-pass member being assigned to a second stage of the balancing circuit, wherein the first high-pass member and the second high-pass member are arranged in a sequence;
shifting a signal backward in terms of phase by a predetermined amount using a first low-pass member and a second low-pass member of a second conductor path, the first low-pass member being assigned to a first stage of the balancing circuit, and the second low-pass member being assigned to a second stage of the balancing circuit, wherein the first low-pass member and the second low-pass member are arranged in a sequence, wherein a sum of the phase shifts in the first conductor path is approximately +90°, and wherein a sum of the phase shifts in the second conductor path is approximately −90°; and
outputting a converted output signal.
